(19) United States
(12) Patent Application Publication
(10) Pub. No.: US 2016/0273156 A1
(43) Pub. Date: Sep. 22, 2016

(54) FIBERGLASS COMPOSITES WITH IMPROVED FLAME RESISTANCE FROM PHOSPHOROUS-CONTAINING MATERIALS AND METHODS OF MAKING THE SAME

(71) Applicant: JOHNS MANVILLE, Denver, CO (US)

(72) Inventors: Guodong Zheng, Highlands Ranch, CO (US); Jawed Asrar, Englewood, CO (US); Elam A. Leed, Littleton, CO (US)

(21) Appl. No.: 15/171,103

(22) Filed: Jun. 2, 2016

Related U.S. Application Data
(62) Division of application No. 13/157,557, filed on Jun. 10, 2011.

(51) Int. Cl. D06M 13/288; C03C 25/16; D04H 3/12; C03C 25/14; C03C 25/24; C03C 25/10

(52) U.S. Cl. CPC D06M 13/288; C03C 25/246; C03C 25/1095; D04H 3/12; C03C 25/14; C03C 25/16; D06M 2101/00

(57) ABSTRACT

Fiberglass products with increased flame resistance are described. The products may include fiberglass-containing thermal insulation that include a plurality of glass fibers coated with a phosphorous-containing flame retardant. The flame retardant may include an organophosphorous compound having a substituted or unsubstituted organophophorous group bonded to a substituted or unsubstituted amide group by a substituted or unsubstituted alkyl group. The fiberglass products may further include fiberglass composites that are about 50 wt. % to about 98 wt. % glass fibers, about 2 wt. % to about 50 wt. % of a binder; and a phosphorous-containing flame retardant. Also described are methods of making fiberglass products with increased flame resistance. These methods may include the steps of contacting glass fibers and/or fiberglass products with a flame retardant mixture that includes a phosphorous-containing compound.

### CROSS-REFERENCE TO RELATED APPLICATION

This application is a division of prior pending U.S. application Ser. No. 13/157,557 filed Jun. 10, 2011. The entire contents of the above-identified application is herein incorporated by reference for all purposes.

### BACKGROUND OF THE INVENTION

Fiberglass, like other glass materials, is non-flammable and not considered a fire danger in building materials and other products. However, modern fiberglass insulation products are also expected to act as barriers to the spread of fire in a home, building, duct, or piece of equipment. For this reason, fiberglass insulation is evaluated for its ability to resist the penetration of flames through the insulation.

These evaluations revealed that the rate of flame penetration can be effected by the properties of the glass fibers, including their basis weight, distribution, diameter, and orientation. However, optimizing just these properties may not be enough to meet the ever more stringent standards for fire and flame resistance set by widely followed standard setting bodies like Underwriters Laboratories.

One area that the standard setting bodies are focusing on is the effect of high temperatures on the ability of fiberglass insulation to resist flame penetration. When temperatures rise above the glass softening temperature for the glass fibers, there is the potential for holes and channels to form in the insulation that may make it easier for flame propagation. Manufacturers have responded by investigating materials that can form decomposition products (e.g., char) around the glass fibers that help structurally support the fibers, thermally insulate the fibers, and/or suppress flame propagation around the fibers.

One such material is the binder commonly used in the fiberglass batt, and especially the mats, of the insulation. Historically, these binders were made from phenol-formaldehyde (PF) and urea-formaldehyde (UF) formulations that are being phased out due to concerns about formaldehyde emissions. Increasingly, formaldehyde-free binder compositions are being used that have no risk of decomposing into formaldehyde. Examples of these compositions include binders made by esterification reactions between the carboxylic acid groups in polycarboxy polymers and the hydroxyl groups in alcohols. Examples also include the use of starches, sugars, proteins, and polyamines, among other classes of compounds, in making formaldehyde-free binders. While the rapid development of many different formaldehyde-free binder compositions have reduced environmental and health risks associated with the older phenol/urea formaldehyde formulations, it has also added to the complexity of developing binders with increased fire and flame resistance.

Thus, there is a need for new compounds and fabrication methods for making fiberglass batts and facers for insulation with improved flame resistance properties without significantly increased health and environmental risks. These and other issues are address in the present application.

### BRIEF SUMMARY OF THE INVENTION

Methods and products are described treating glass fibers with flame retardant compositions to increase the flame resistance of the fibers. The flame retardant compositions may include phosphorous-containing compounds that provide structural support and thermal insulation to glass fibers exposed to a flame front. The phosphorous-containing compounds may include organophosphorous compounds having an organophosphorous group bonded to an alkyl linking group that is also bonded to an amide group. These compounds decompose at high temperature to help form a char around the glass fibers. The char insulates the glass fibers from the surrounding heat to slow the melting of the fibers. The char may also retain its rigidity to bolster the structural integrity of the softening glass fibers.

In addition to the one or more phosphorous-containing compounds, the flame retardant compositions may include additional flame retardant compounds such as metal hydroxides, carbon black, and/or halogen-containing compounds, among others. The flame retardant may further include vermiculite and/or expandable graphite to supplement the insulating and reinforcing properties of the char. In many instances, the flame retardant compositions interfere with the chemical reactions of flame propagation and undergo endothermic decomposition reactions that decrease the temperature (or at least slow the increase in temperature) around the glass fibers.

Embodiments of the invention include fiberglass-containing thermal insulation with increased resistance to flame penetration. The insulation may include glass fibers at least partially coated with a organophosphorous-containing flame retardant. The flame retardant may include one or more organophosphorous compounds that may include a substituted or unsubsituted organophosphorous group bonded to a substituted or unsubstituted amide group by an substituted or unsubsituted alkyl group. The flame retardant may optionally also include additional flame retardant materials such as vermiculite and/or expandable graphite, one or more metal hydroxides, carbon black, and/or one or more halogen-containing compounds, among other materials.

Embodiments of the invention also include fiberglass composites with improved flame resistance. The composites may include about 50 wt. % to about 98 wt. % glass fibers; about 2 wt. % to about 50 wt. % of a binder; and a flame retardant. The flame retardant may include an organophosphorous compound having a substituted or unsubstituted organophophorous group bonded to a substituted or unsubstituted amide group by a substituted or unsubstituted alkyl group.

Embodiments of the invention still further include methods of making glass fibers with improved flame resistance. The methods may include, among other steps, contacting glass fibers with an aqueous flame retardant mixture that includes an organophosphorous compound having a substituted or unsubstituted organophophorous group bonded to a substituted or unsubstituted amide group by a substituted or unsubstituted alkyl group. The glass fibers are dried the to form fibers with improved flame resistance.

Embodiments of the invention may also further include methods of making fiberglass composites with improved flame resistance. The methods may include, among other steps, combining a binder composition with treated or untreated glass fibers, and curing the combination to form a fiberglass composite. An flame retardant composition that includes one or more organophosphorous compounds may then be applied to the fiberglass composite to impart increased flame resistance to the composite.

Embodiments of the invention may still also include additional methods of making a fiberglass composite with increased flame resistance. The methods may include, among other steps, combining glass fibers with a binder composition, and applying a flame retardant mixture to the combination of the glass fibers and the binder composition. The flame retardant mixture may include an organophosphorous compound having a substituted or unsubstituted organophophorous group bonded to a substituted or unsubstituted amide group by a substituted or unsubstituted alkyl group. The combination of the glass fibers, the binder composition, and the flame retardant mixture may be cured to forming the fiberglass composite.

Additional embodiments and features are set forth in part in the description that follows, and in part will become apparent to those skilled in the art upon examination of the specification or may be learned by the practice of the invention. The features and advantages of the invention may be realized and attained by means of the instrumentalities, combinations, and methods described in the specification.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A is a flowchart showing selected steps in methods of treating fiberglass to improve its flame resistance according to embodiments of the invention;

FIG. 1B is a flowchart showing selected steps in methods of making fiberglass composites according to embodiments of the invention;

FIG. 1C is a flowchart showing selected steps in additional methods of making fiberglass composites according to embodiments of the invention;

FIG. 1D is a flowchart showing selected steps in additional methods of making fiberglass composites according to embodiments of the invention;

FIG. 2 is a flowchart showing selected steps in a method of making a fiberglass-containing product according to embodiments of the invention;

FIG. 3 is a simplified illustration of a fiberglass product according to embodiments of the invention;

FIG. 4 is an illustration of treated and untreated fiberglass insulation following a flame propagation test; and

FIG. 5 is an illustration showing the extent of lasting char formation on fiberglass insulation treated with two different phosphorous-containing flame retardants.

### DETAILED DESCRIPTION OF THE INVENTION

Fiberglass insulation is a non-flammable material that intrinsically meets most of the requirements for a fire resistant material. However, some applications and environments call for fiberglass products that can remain fire and flame resistant for a specified period of time at higher temperatures where the glass fibers can soften, deform, or even melt. Fiberglass products are described that include flame retardants that provide structural support, thermal insulation, and/or flame repressing properties to a fiberglass composite that extend the time fiberglass-containing products can suppress the propagation of fire and flames.

### Exemplary Fiberglass Composites

Exemplary fiberglass composites include glass fibers that are treated with a phosphorous-containing flame retardant. The composites may include fiberglass thermal insulation having improved flame resistance imparted when the flame retardant forms a char around the glass fibers. The flame retardant (or components thereof) may optionally be incorporated into a binder composition that binds together glass fibers in the composite. Exemplary composites may have the glass fibers making up about 50 wt. % to about 98 wt. %, and the binder making up about 2 wt. % to about 50 wt. %, of the composite.

The glass fibers may have a variety of spatial dimensions depending on the composite. For example, the fibers may have an average length of about 1 cm to about 10 cm (e.g., 1.9±0.2 cm), and an average diameter of about 3 μm to about 20 μm (e.g., about 10 μm to about 14 μm), among other ranges. The fibers may also have a variety of distribution characteristics such as basis weight. For example, the basis weight of the glass fibers may range from about 135 g/m² to about 700 g/m². Typically, basis weights ranging from about 300 g/m² to about 700 g/m² are considered higher weight insulation (e.g., flexible duct insulation typically ranges from about 350 g/m² to about 700 g/m²), while insulation with basis weights ranging from about 135 g/m² to about 300 g/m² are considered lower weight insulation. The glass fibers may be arranged in a woven or non-woven fashion in the mat.

In some embodiments, the glass fibers may be blended with other types of fibers, such as mineral fibers, graphite fibers, synthetic polymer fibers (e.g., polyethylene, polypropylene, polyester, nylon, etc.), natural fibers (e.g., cotton, hemp, jute, flax, kenaf, etc.), and cellulose fibers, among other types of fibers. The amount of glass fibers in the composite may range from about 100 wt. % of the fibers to 90 wt. %, 80% wt. %, 75 wt. %, etc.

The flame retardant compositions are compatible with a variety of binder compositions. These binder compositions may include single species or blends of polymer binders such as acrylic binder, a urea-formaldehyde binder, a phenol-formaldehyde binder, a silicate binder, a melamine-formaldehyde binder, and a latex binder, among other kinds of binders. They may also include ethylenically-unsaturated addition polymers and/or co-polymers such as styrene maleic anhydride, among others. The binders may also include starches, sugars, and/or proteins, having varying degrees of polymerization, among other materials.

The binders may be made from binder compositions that include precursors that form the binder. These precursors may include monomers and/or intermediate oligomers and polymers that are polymerized in the final binder. Exemplary binder precursors may include carboxylic acids, anhydrides, alcohols, polyols, vinyl monomers, and polyols, among others. Binder precursors may also include polymerization catalysts, initiators, accelerators, pigments, defoamers, crosslinking agents, plasticizers, corrosion inhibitors, anti-microbial compounds, extenders, and/or anti-fungal compounds, among other kinds of compounds.

The flame retardant mixture and/or binders may also include filler materials such as kaolinite, mica, talc, fly ash, gypsum, montmorillonite, bentonite, smectite, calcium carbonate, clay, THA, and/or titanium dioxide, among other fillers. These fillers may be used to adjust, among other properties, the color, clarity, texture, weight, strength, flexibility, toughness, and flame/heat resistance of the composite. If fillers and flame retardant are added to the binder composition, exemplary ratios weight ratios of flame retardant to filler may include ranges from about 1:2 to about 2:1.

The phosphorous-containing compounds in the flame retardants may be water soluble so it can be applied in an aqueous solution to the untreated glass fibers with good coverage and coupling to the exposed glass fiber surfaces. Exemplary phosphorous-containing compounds may include an organophosphorous compound having a substituted or unsubstituted organophophorous group bonded to a substituted or unsubstituted amide group by a substituted or unsubstituted alkyl group.

The organophosphorous group may include a oxyphosphorous compounds that have at least one phosphorous-carbon bond, such as:

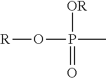

where the R groups may be independently a hydrogen moiety (H), an alkyl group (e.g., a C₁-C₃ alkyl group), or a halogenated alkyl group (e.g., a C₁-C₃ halogenated alkyl group), among other groups.

The unattached bond on the right of the organophosphorous group bonded may be bonded to a carbon atom of the substituted or unsubstituted alkyl linking group that links the organophosphorous group to the amide group. The alkyl linking group may be a branched or unbranched alkyl chain having from 1 to about 5 carbon atoms in its backbone. Substituted linking groups may include halogen species (e.g., F, Cl, Br) that replace one or more of the hydrogen moieties of the alkyl group. Exemplary linking groups may include:

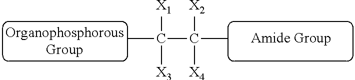

where X₁, X₂, X₃, and X₄ are independently, H, CH₃, halogenated —CH₃, F, Cl, or Br. It should be appreciated that the two carbon atoms shown in the backbone of the alkyl linking group may be extended to a three, four, five, etc., carbon chain with additional substituted or unsubstituted “X” moieties.

The amide group may include an amide with substituted or unsubstituted moieties bonded to the amide nitrogen. A exemplary structure of the amide group may include:

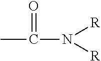

where the R groups may be independently H, OH, and C₁-C₅ alkyl group, a C₁-C₅ halogenated alkyl group, a C₁-C₅ alcohol group, or a C₁-C₅ halogenated alcohol group, among other groups.

Exemplary structures of complete phosphorous-containing compounds may include:

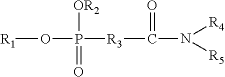

where R₁ and R₂ are independently H, a C₁-C₃ alkyl group, or a halogenated C₁-C₃ alkyl group, R₃ is a halogenated or unhalogenated alkyl group, and R₄ and R₅ are independently H, OH, and C₁-C₅ alkyl group, a C₁-C₅ halogenated alkyl group, a C₁-C₅ alcohol group, or a C₁-C₅ halogenated alcohol group.

Additional exemplary structures may include:

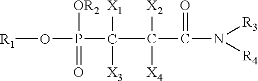

where R₁ and R₂ are independently H, a C₁-C₃ alkyl group, or a halogenated C₁-C₃ alkyl group, X₁, X₂, X₃, and X₄ are independently, H, CH₃, halogenated —CH₃, F, Cl, or Br, and R₃ and R₄ are independently H, OH, and C₁-C₅ alkyl group, a C₁-C₅ halogenated alkyl group, a C₁-C₅ alcohol group, or a C₁-C₅ halogenated alcohol group.

A specific exemplary phosphorous-containing compound is phosphonic acid, P-[3-[hydroxymethyl)amino]-3-oxopropyl]-, dimethyl ester:

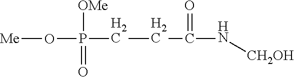 [SMILES: COP(=O)(CCC(=O)NCO)OC]

The compound is available commercially under the tradename Pyrovatex® CP NEW from Huntsman International.

In addition to the above-described phosphorous-containing compounds the flame retardant composition may also optionally include additional polyphosphates, phosphate esters and phosphate amides, among other kinds of phosphorous compounds. Polyphosphates may include ammonium polyphosphates —[NH₄PO₃]ₙ-made from monomer units of an orthophosphate radical of a central P atom bonded to three oxygens that give the anion a negative charge that is balanced by the ammonium cation. The phosphorous compounds may also include organic phosphorous compounds such as organic phosphate esters having the formula P(═O)(OR)₃, wherein at least one of the R groups is a substituted or unsubstituted, saturated or unsaturated, halogenated or unhalogenated, alkyl, aryl, or phenyl moiety, among other organic moieties.

When the phosphorous-containing compounds are applied as a coating or part of a sizing composition on the glass fibers, they quickly decompose to form a char around the fibers when exposed to high heat and flames. The char provides both structural support and thermal insulation to the underlying glass fibers. It may also reduce the volume of interstitial spaces between the fibers to help reduce the velocity of hot air, combustion gases, etc., thought the composite. In some instances, the phosphorous-containing compounds may decompose under heat to form phosphoric acid groups that act as acid catalysts in the dehydration of alcohol groups found in organic binder systems. This dehydration process temporarily destabilizes the phosphoric acid groups by converting them into phosphate esters that decompose to release carbon dioxide and regenerate the phosphoric acid group. The released carbon dioxide displaces combustible gases like molecular oxygen and decomposing organic compounds to help suppress flame propagation. The pressure from the buildup of the carbon dioxide may also help expand the volume of surrounding material (e.g., the binder) to constrict or close channels for conducting flames and combustible gases through the composite.

The flame retardant may also optionally include components such as vermiculite, expandable graphite, a metal hydroxide, carbon black, and/or a halogen-containing compound, among other compounds. These components may provide structural integrity and/or thermal insulation to softening glass. Alternately or in addition, they may interfere chemically with flame propagation by neutralizing flame propagating species and/or displacing and diluting combustible gases with more stable species such as water and carbon dioxide.

Vermiculite is a natural mineral whose composition includes a hydrated magnesium-iron-aluminum-silicate (i.e., a phyllosilicate). In some forms vermiculite's chemical formal may be represented as (MgFe,Al)₃(Al,Si)₄O₁₀(OH)₂.4H₂O. In additional forms, vermiculite's empirical formula may be represented as Mg_{1.8}Fe_{0.9}Al_{4.3}SiO₁₀(OH)₂.4H₂O. Vermiculite particles may be added to the fibers and/or binder composition as dry particles or a dispersion in a liquid solution (e.g., water).

Exemplary metal hydroxide compounds can release water in endothermic decompositions when exposed to sufficiently high temperatures. For example, magnesium hydroxide (Mg(OH)₂) decomposes at about 330° C. to form magnesium oxide (MgO) and water (H₂O). Similarly, aluminum tri-hydroxide (Al(OH)₃) decomposes about 230° C. to form aluminum oxide (Al₂O₃) and water. The water released suppresses combustion and flame propagation through the composite. In some embodiments, the metal hydroxides may be combined with carbon black in the fire retardant.

Exemplary halogen-containing compounds may include compounds such as organo-halogen compounds (e.g., a halogenated aliphatic compound). Exemplary halogen-containing compounds may also include brominated aliphatic and/or aromatic compounds. When the halogen-containing compounds decompose at high temperature, they release halogen-containing species that quickly combine with energetic free radical combustion species to neutralize them and interrupt some of the major exothermal reaction channels of the combustion.

### Exemplary Methods of Making Treated Fiberglass and Composites

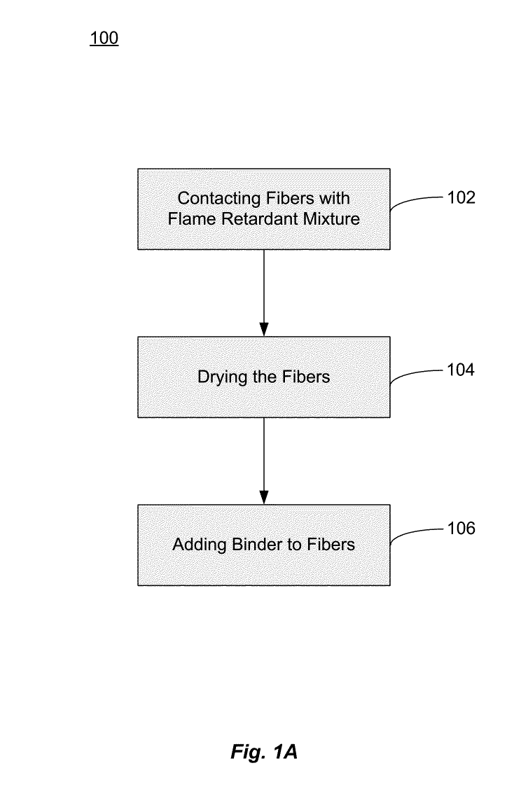

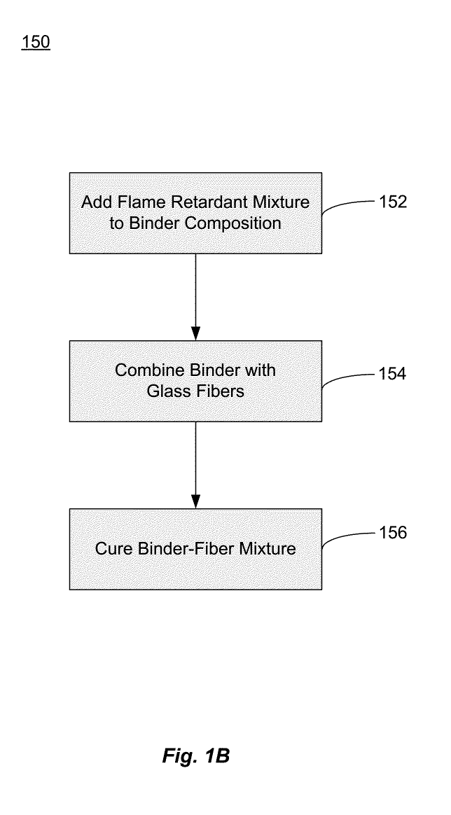

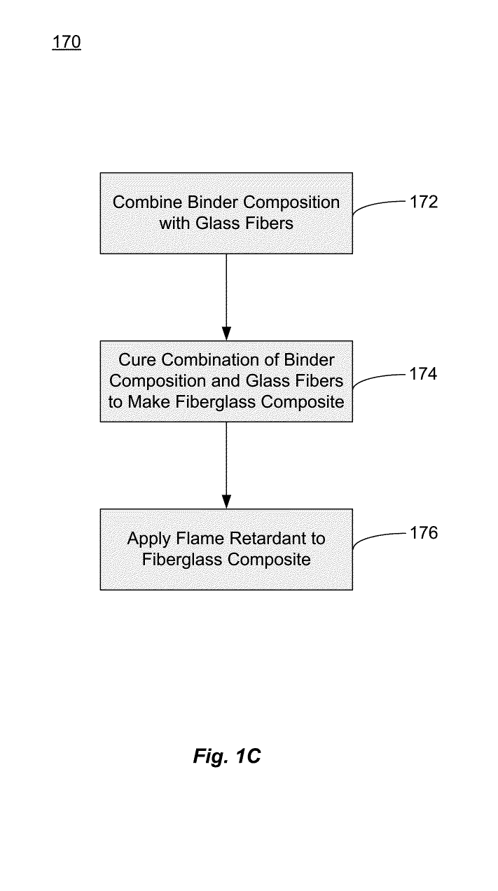

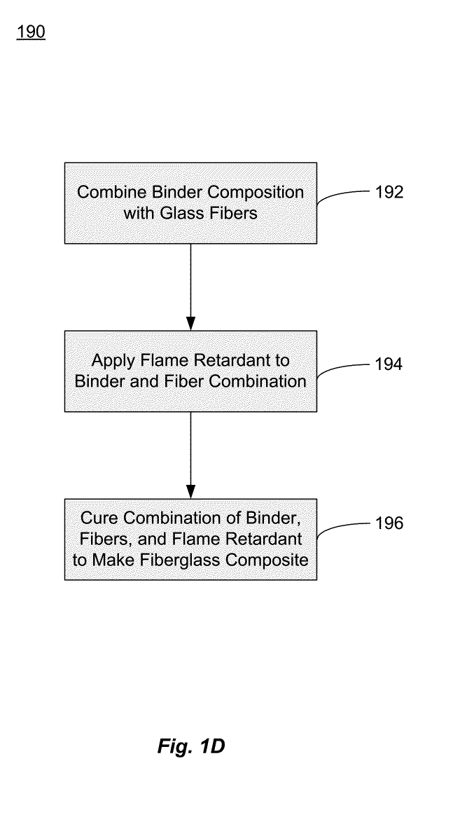

FIG. 1A shows a flowchart with selected steps in a method of making glass fibers with improved flame resistance according to embodiments of the invention. The method 100 includes the step of contacting glass fibers with a flame retardant mixture 102. The mixture may contact the fibers by any number of processes such as spraying, coating, and dipping, among other processes. For example, the glass fibers may be transported on a conveyor belt through a spray of the flame retardant mixture. In another example, the glass fibers and mixture may be mixed together in a slurry that is deposited on a moving screen to dewater the slurry and form a wet collection of the fibers. The wet fibers may then be transported either to a drying process (e.g., an oven) or contacted with additional mixtures (e.g., a binder composition) before being dried and/or cured.

As noted above, the flame retardant mixture may include one or more phosphorous-containing compounds. The mixture may have the phosphorous-containing compound dispersed or dissolved in an aqueous solution that is sprayed, coated, mixed, dipped, etc. on the glass fibers. The mixture may also include flame retardant compounds such as vermiculite and/or expandable graphite, metal hydroxides, carbon black, and/or a halogen-containing compounds, among other compounds. The mixture may further include organic and/or inorganic sizing compounds that aid in the uniform distribution and/or adherence of the flame retardant to the glass fibers. In some instances, these sizing compounds may include precursors that are similar and/or identical to the binder precursors.

The method 100 further includes drying the glass fibers to form the fibers with improved flame resistance 104. The drying process may include removing excess flame retardant mixture from the glass fibers in a dewatering step (e.g., draining the excess mixture though a porous screen or mesh that supports the glass fibers). Alternatively (or in addition) the drying process may include increasing the temperature of the glass fibers by, for example, placing the fiber in an oven or exposing the fibers to a heat source such as a heating element or blown hot air.

A binder composition may be optionally added to the treated glass fibers 106. The binder composition may be added before or after the glass fibers are dried. When the binder is added to the dried glass fibers, the combination of the binder composition and treated fibers may be dried and/or cured to form a fiberglass composite of the fibers and binder. The binder composition may optionally include the same or different flame retardant compounds than those used in the flame retardant mixture.

The flame retardant mixture may act as a sizing composition that adds flame retardants to the glass fibers' surfaces without binding the fibers together, or a binder composition that can also form a binder when cured. FIG. 1B shows selected steps in methods 150 of combing glass fibers with a flame retardant mixture that also acts as a binder composition. The method 150 includes the step of adding a flame retardant to a binder composition to form the flame retardant mixture 152. The flame retardant may include phosphorous-containing compound that is added as a liquid (e.g., aqueous solution) to the binder composition. Alternatively (or in addition) additional flame retardant components may be added to the binder composition independently from or with the phosphorous containing compound. As noted above, the flame retardant components may include a phosphorous compound, a metal hydroxide, carbon black, and/or a halogen-containing compound, among other compounds.

The binder composition to which the flame retardant is added may include a mixture of precursors that form the binder for the fibers of the composite when cured. Exemplary binder compositions may include starting materials for a polymeric binder such as an acrylic binder, a urea-formaldehyde binder, a phenol-formaldehyde binder, a silicate binder, a melamine-formaldehyde binder, and a latex binder, among other kinds of binders. They may also include ethylenically-unsaturated addition polymers and/or co-polymers such as styrene maleic anhydride, among others. The pre-polymerized binder composition may include starches, sugars, and/or proteins, among other materials, having varying degrees of polymerization.

Exemplary binder compositions may include one or more organic polyacids and one or more polyols that polymerize to form a formaldehyde-free binder such as a polyacrylic binder. The polyol may include three or more —OH moieties (e.g., triethanolamine, glycerol, etc.) that acts as a crosslinking agent as well as a co-monomer of the acrylic polymer backbone. The binder compositions may also include sugars, starches and proteins that act as extenders, covalently bound constituents of the polymer binder, or both.

Exemplary binder compositions that form silicon-containing binders may also be used. These binder compositions may include silicon silicate, potassium silicate, and/or quaternary ammonium silicate, among other silicates. The binder compositions may optionally further include organic compounds, oligomers, and/or polymers (e.g., latex, polyols, sorbitol, sugars, glycerin, etc.). The binder compositions may further include surfactants (e.g., anionic and/or non-ionic surfactants), curing aids such as metals salts (e.g., CaCl₂, MgSO₄, Al₂(SO₄)₃, ZnSO₄, Al PO₄, etc.), defoamers, water repellents, and fillers (e.g., clays, Atomite, etc.), among other compounds.

The flame retardant mixture that includes the binder composition may then be combined with the glass fibers 154 by spraying, mixing, coating, dipping, etc., as described above. They may also include curtain coating the binder on the fibers, and dip-and-squeeze coating the binder, among other application techniques. The combination of the binder mixture and glass fibers may then be dried and/or cured 156 to form a fiberglass composite. Exemplary techniques to dry and cure the applied binder may include oven drying and dry laying, among other techniques. In the final composite the glass fibers may, for example, represent about 50 wt. % to 98 wt. % of the composite, and the binder may represent about 2 wt. % to about 50 wt. % of the composite. In additional examples, the flame retardant in the binder and/or attached to the glass fibers may represent about 1 wt. % to about 25 wt. % of the final composite.

In additional methods the flame retardant mixture may be added to cured fiberglass composites as shown in FIG. 1C. The method 170 may include the step of combining a binder composition with glass fibers 172. The fibers may be untreated, or may optionally be treated with a sizing composition that includes the flame retardant. The combined mixture is then cured to form the fiberglass composite 174. The flame retardant mixture may then be applied to the fiberglass composite 176 as it is curing and/or after curing is finished. Exemplary applications of the flame retardant include spraying the retardant on exposed surfaces of the fiberglass composite.

In still other additional methods 190, the flame retardant mixture may added to the combination of the glass fibers and binder composition before it is cured or in a partially cured or prepreg state. The method 190 may include the step of combining the binder composition with glass fibers 192, followed by applying the flame retardant to the combination of binder composition and glass fibers 194. The combination of binder composition and glass fibers may be uncured, partially cured (i.e. B-stage cured), or a prepreg. The combination of the binder composition, fibers, and flame retardant mixture may then be cured or melted to form the fiberglass composite with improved flame resistance.

### Exemplary Methods of Making Fiberglass Insulation Products

The treated fiberglass and fiberglass composites described above may be used to make fiberglass insulation products with improved flame resistance. For example, the treated glass fibers may be formed into a fiberglass batt with improved flame resistance, as well as a flame resistant fiberglass mat. The mat and batt may function as insulation products themselves, or the mat may act as a facer that is attached to a fiberglass batt to make another insulation product. The same or different flame retardants may be incorporated into the mat, the batt, or both.

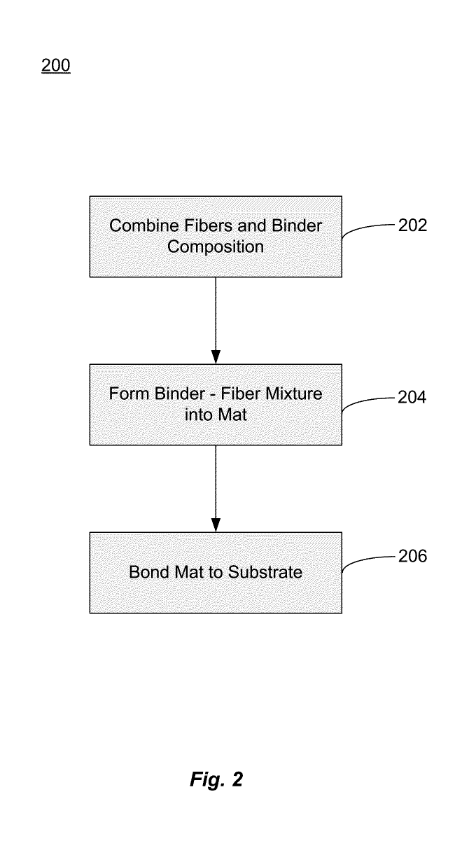

FIG. 2 illustrates selected steps in a method 200 of making a fiberglass-containing products according to embodiments of the invention. The method 200 may include making a fiberglass facer mat with increased flame resistance by combining glass fibers with a binder composition 202 and forming the combination into the fiberglass facer mat 204. Flame retardant that imparts the increased flame resistance to the mat may be incorporated into the binder, attached to the glass fibers, or both.

The fiberglass facer mat may then be bonded to a substrate material 206. The substrate may be a fiberglass batt formed from woven and/or non-woven glass fibers that may also have been treated with a flame retardant either on the fibers and/or in a binder that holds together the fibers. Alternatively (or in addition) the substrate may be insulation foam board that optionally includes flame retardant and glass fibers. The thickness of the insulation formed by the mat and batt may range, for example, from about 1 cm to about 5 cm or more.

The fiberglass facer mat and the substrate may be bonded while being formed or formed separately and then bonded. For example, the method 200 may involve first forming the fiberglass mat and then forming the fiberglass insulation batt on the mat by applying the mat to a collection chain on which the insulation batt is formed. Alternatively, both the mat and batt may be separately formed before being joined together.

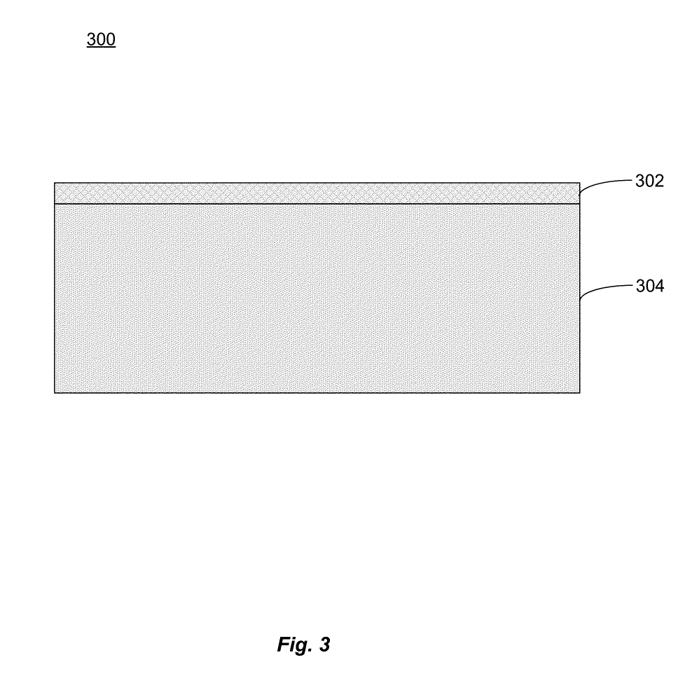

Referring now to FIG. 3, a simplified illustration of a fiberglass product is shown. The fiberglass product 300 includes a fiberglass mat facer 302 that includes glass fibers held together by a binder. A flame retardant may be present in the binder, on the glass fibers, or both. The mat facer 302 is bonded to a substrate such as a fiberglass batt 304. The mat may be bonded to the batt 304 by cured binder in the mat 302 and/or batt 304. Alternatively, the mat 302 may be bonded to a separately formed batt 304 using an adhesive.

The exemplary fiberglass composites, such as fiberglass insulation batt, fiberglass duct insulation, fiberglass mats, etc., treated with the present flame retardant compositions have an increased probability of passing a flame penetration test of the UL 181 Standard. This Standard was developed by Underwriter's Laboratories, Inc. for air ducts and connectors. The standard used in the present application is the UL 181 Standard for Factory-Made Air Ducts and Air Connectors, Flame Penetration Test (Section 10). In this test, the treated fiberglass composite is flattened and mounted in a frame that is placed over a flame at about 774° C., with the outside face of the duct in contact with the flame. The framed sample is loaded with a 3.6 kg weight over an area of 2.5 cm×10.2 cm. The fiberglass composite samples will fail if either the weight falls through the sample or the flame penetrates the sample. The sample is exposed to the flame for a period of 30 minutes.

The flame resistant fiberglass insulation may have applications as duct liner (e.g., Linacoustic RC™), and equipment liner (e.g., Micromat®), among other applications. Fiberglass duct liner are often designed for lining sheet metal ducts in air conditioning, heating and ventilating systems, and may help to control both temperature and sound. Fiberglass equipment liners are often blanket-type fiberglass insulation, used for thermal and acoustical control in HVAC equipment, as well as other equipment where reduced air friction, increased damage resistance, reduced operational noise, increased thermal performance, increased resistance to air erosion, increased ease of fabrication, installation, and handling, and attractive appearance, among other improved characteristics, are desired. Additional application of fiberglass equipment liners include their use with air conditioners, furnaces, VAV boxes, roof curbs, among other types of equipment.

### EXPERIMENTAL

Comparative tests were conducted to demonstrate the improved flame resistance of fiberglass products coated with fire retardants like those described above. These tests include subjecting fiberglass batts and textiles treated with a flame retardant mixture to flame tests for an extended period of time. Comparative tests were performed on similar fiberglass materials that were not treated with the flame retardant mixture.

Experiment #1 Confirming the Formation of Char Around Glass Fibers Treated with An Organophosphorous Flame Retardant

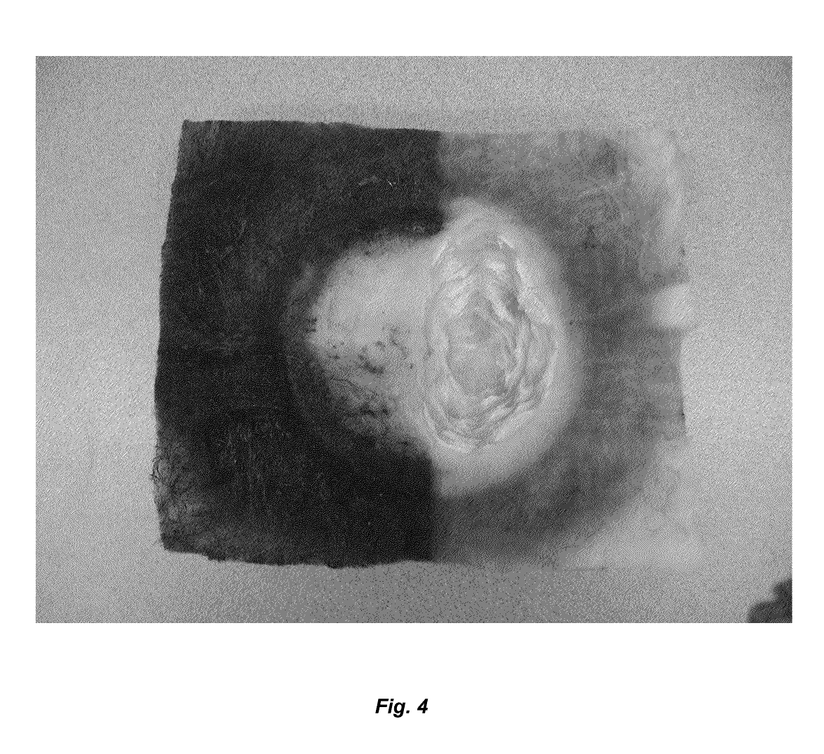

FIG. 4 shows the condition of a 4 inch square sample of fiberglass insulation that was exposed to a Bunsen burner flame for 30 minutes. The left half of the same was treated with an organophosphorous flame retardant while the right half was not treated with any flame retardant. The figure shows the surface of the treated half of the insulation formed a layer of char that remained intact for the duration of the flame exposure. In contrast, the untreated half on the right showed some darkening (presumably from dehydrated binder) but no char formation. The untreated half also showed significant melting and pitting of the fiberglass that would indicate a failure of a standardized flame penetration test such as Underwriters' Laboratory Test 181 for flame penetration for fiberglass.

### Experiment #2 UL 181 Flame Penetration Tests for Treated and Untreated Fiberglass Insulation

A group of seven fiberglass samples (Samples A-G) were prepared for the UL 181 flame penetration test. Sample A was a control sample of fiberglass insulation that was not treated with a flame retardant, while samples B-G were treated with a variety of phosphorous containing flame retardants. For all the samples, fiberglass insulation with a low average area weight was used to increase the probability that a successful test was attributed to the flame retardant instead of the density of the glass fibers. Moreover, the samples were exposed to the UL 181 flame penetration furnace for up to 45 minutes instead of the standard 30 minutes to better differentiate the flame resistance characteristics of the treated samples. Table 1 shows the test results for Samples A-G:

TABLE 1
UL 181 Flame Penetration Test Results of
Ducts Coated with Fiberglass Insulation

| | | Average | Average | Average | Flame |
|---|---|---|---|---|---|
| | | Fiberglass | Coating | Flame | Pene- |
| | | Insulation | Area | Pene- | tration |
| Sam- | | Area Weight | Weight | tration | Pass |
| ple | Coating Type | (g/ft²) | (g/ft²) | Time (min) | Rate |
| A | Control (No | 35.0 | 0.00 | 16.7 | 28% |
| | Coating) | | | | |
| B | Durant 40 | 35.1 | 1.11 | 22.6 | 38% |
| C | Kronitex CDP | 35.1 | 0.84 | 9.0 | 0% |
| D | Pyrol 6 | 35.1 | 1.22 | 19.0 | 25% |
| E | Pyrovetax SVC | 34.6 | 1.07 | 15.8 | 25% |
| F | Blend of Flovan | 34.2 | 1.62 | 22.7 | 25% |
| | CGN:Pyrovetax | | | | |
| | SVC (1:1) | | | | |
| G | Pyrovatex CP | 35.1 | 0.88 | 34.7 | 72% |
| | New | | | | |

The test results from Table 1 show that most of the treated fiberglass samples had pass rates that were approximately equivalent to untreated control Sample A. Observations of the tested samples revealed that very little or no char was observed, indicating that it was quickly burned away from the underlying glass fibers or was never formed at all. Only Sample G phosphonic acid, P-[3-[hydrontmethyl)amino]-3-oxopropyl]-, dimethyl ester) showed significant char formation at the end of the test period, which correlated with the significantly higher flame penetration pass rate (72%) for this sample.

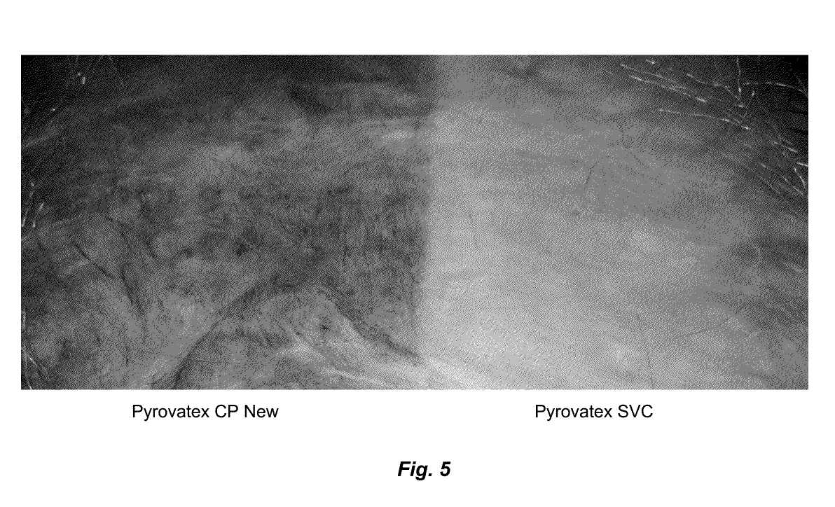

FIG. 5 compares the extent of char formation on fiberglass insulation treated with the organophosphorous flame retardant of Sample G (left side) versus insulation treated with Sample E, a cyclic phosphonate sold under the tradename Pyrovetax SVC (right side). Both samples were exposed to a flame penetration furnace in conformance with the UL 181 standard for 1 minute and then removed to observe the surface exposed to flame. FIG. 5 shows the left side treated with Sample G formed a significant char layer, with the char staying attached to the glass surface without appreciable oxidation or spelling. In contrast, the right side treated with Sample E had some char form initially but shows little char remaining after exposure to the flame furnace for 1 minute. The results in FIG. 5 and Table 1 show a correlation between char formation and increased flame resistance for fiberglass insulation.

More surprisingly, the results also show that selection of the organophosphate compound can have a strong effect on both the quantity and quality of char formation on glass fibers exposed to a flame front. For example, Samples G and E are both organic phosphonate compounds that have been used as flame retardants in the clothing and fabric industries. However, the cyclic phosphonate (Sample E) did not produce a lasting char on the glass fibers similar to the phosphonate compound shown in Sample G. Many phosphorous-containing flame retardants capable of forming a char layer may form chars that do not uniformly cover the glass fibers, last only a short duration when exposed to a flame front, or both.

Having described several embodiments, it will be recognized by those of skill in the art that various modifications, alternative constructions, and equivalents may be used without departing from the spirit of the invention. Additionally, a number of well-known processes and elements have not been described in order to avoid unnecessarily obscuring the present invention. Accordingly, the above description should not be taken as limiting the scope of the invention.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included.

As used herein and in the appended claims, the singular forms “a”, “an”, and “the” include plural referents unless the context clearly dictates otherwise. Thus, for example, reference to “a process” includes a plurality of such processes and reference to “the glass mat” includes reference to one or more glass mats and equivalents thereof known to those skilled in the art, and so forth.

Also, the words “comprise,” “comprising,” “include,” “including,” and “includes” when used in this specification and in the following claims are intended to specify the presence of stated features, integers, components, or steps, but they do not preclude the presence or addition of one or more other features, integers, components, steps, acts, or groups.

What is claimed is:

1. A method of making glass fibers with improved flame resistance, the method comprising:
contacting glass fibers with an aqueous flame retardant mixture comprising an organophosphorous compound having a substituted or unsubstituted organophophorous group bonded to a substituted or unsubstituted amide group by a substituted or unsubstituted alkyl group; and
drying the glass fibers to form the fibers with improved flame resistance.

2. The method of claim 1, wherein the flame retardant mixture further comprises one or more additional flame retardant compounds selected from the group consisting of vermiculite, expandable graphite, a metal hydroxide, carbon black, and a halogen-containing compound.

3. The method of claim 1, wherein the flame retardant mixture further comprises one or more compounds selected from the group glycerin, sorbitol, sugar, starch, protein, and latex.

4. The method of claim 1, wherein the flame retardant mixture further comprises one or more binder precursors selected from the group consisting of a carboxylic acid, an anhydride, an alcohol, a vinyl compound, a polyol, a polymerization catalyst, an accelerator, a corrosion inhibitor, and an extender.

5. The method of claim 1, wherein the flame retardant mixture further comprises kaolinite, mica, talc, fly ash, gypsum, montmorillonite, bentonite, smectite, calcium carbonate, clay, THA, or titanium dioxide.

6. The method of claim 1, wherein the flame retardant mixture contacts the glass fibers by spraying, coating, or dipping the flame retardant mixture on the glass fibers.

7. The method of claim 1, wherein the drying of the glass fibers comprises blowing heated air on the glass fibers.

8. The method of claim 1, wherein the drying of the glass fibers comprises heating the glass fibers in an oven.

9. The method of claim 1, wherein the method further comprises forming the fibers with improved flame resistance into a fiberglass insulation batt.

10. The method of claim 1, wherein the method further comprises forming the fibers with improved flame resistance into a fiberglass mat.

11. The method of claim 1, wherein the method comprises forming the fibers with improved flame resistance into a fiberglass composite that has a higher passage rate for a flame penetration test of a UL 181 Standard compared to the same fiberglass composite that did not have fibers treated with the flame retardant mixture.

12. A method of making a fiberglass composite with increased flame resistance, the method comprising:
combining glass fibers with a binder composition;
curing the combination of glass fibers and the binder composition to form the fiberglass composite; and
applying a flame retardant mixture to the fiberglass composite, wherein the flame retardant mixture comprises an organophosphorous compound having a substituted or unsubstituted organophophorous group bonded to a substituted or unsubstituted amide group by a substituted or unsubstituted alkyl group.

13. The method of claim 12, wherein the fiberglass composite comprises fiberglass insulation batt or fiberglass duct insulation.

14. The method of claim 12, wherein the fiberglass composite with increased flame resistance has a higher passage rate for a flame penetration test of a UL 181 Standard compared to the same fiberglass composite that was not treated with the flame retardant mixture.

15. A method of making a fiberglass composite with increased flame resistance, the method comprising:
combining glass fibers with a binder composition;
applying a flame retardant mixture to the combination of the glass fibers and the binder composition, wherein the flame retardant mixture comprises an organophosphorous compound having a substituted or unsubstituted organophophorous group bonded to a substituted or unsubstituted amide group by a substituted or unsubstituted alkyl group
curing the combination of the glass fibers, the binder composition, and the flame retardant mixture to form the fiberglass composite.

16. The method of claim 15, wherein the fiberglass composite with increased flame resistance has a higher passage rate for a flame penetration test of a UL 181 Standard compared to the same fiberglass composite that was not treated with the flame retardant mixture.
